(19) United States
(12) Patent Application Publication
(10) Pub. No.: US 2022/0142350 A1
(43) Pub. Date: May 12, 2022

(54) METHOD, APPARATUS AND SYSTEM FOR INSTRUCTING TOOTH BRUSHING, PROCESSING DEVICE AND STORAGE MEDIUM

(71) Applicant: BOE Technology Group Co., Ltd., Beijing (CN)

(72) Inventors: Jiao HUANG, Beijing (CN); Yanyang HU, Beijing (CN)

(21) Appl. No.: 17/434,378

(22) PCT Filed: Jan. 21, 2021
(86) PCT No.: PCT/CN2021/073156

§ 371 Date: Aug. 26, 2021

(30) Foreign Application Priority Data
Jan. 22, 2020 (CN) 202010073024.5

(51) Int. Cl. A46B 15/00; A61C 17/22; G09B 19/00

(52) U.S. Cl. CPC A46B 15/0006; A46B 2200/1066; G09B 19/0084; A61C 17/22

(57) ABSTRACT

A method, an apparatus and a system for instructing tooth brushing, a processing device and a storage medium relate to the field of intelligent home technologies. The method includes: acquiring tooth brushing data collected by an electric toothbrush (101) during a tooth brushing process of the electric toothbrush (101) based on a target tooth brushing solution, wherein the tooth brushing data includes: a tooth brushing duration and a tooth brushing pressure; acquiring a tooth brushing evaluation result based on the tooth brushing data; outputting the tooth brushing evaluation result; and sending tooth brushing instruction information based on tooth brushing information. The tooth brushing information includes: at least one of the tooth brushing evaluation result and the tooth brushing data. The tooth brushing instruction information is configured to instruct a user of the electric toothbrush (101) to brush teeth. The user of the electric toothbrush learns about a tooth brushing quality of a current tooth brushing process by checking the tooth brushing evaluation result, and improves the next tooth brushing process according to the tooth brushing instruction information to improve the subsequent tooth brushing quality.

### CROSS-REFERENCE TO RELATED APPLICATION

This application claims priority of the Chinese Patent Application No. 202010073024.5, filed on Jan. 22, 2020 and entitled “METHOD AND APPARATUS FOR INSTRUCTING TOOTH BRUSHING, AND TOOTHBRUSH,” the disclosure of which is incorporated herein by reference in its entirety.

### TECHNICAL FIELD

The present disclosure relates to a method, an apparatus and a system for instructing tooth brushing, a processing device, and a storage medium.

### BACKGROUND

With people's awareness of personal care, more and more people begin to pay attention to oral and dental health. A better tooth brushing habit is one of the most important foundations for guaranteeing the oral and dental health. Therefore, evaluating the quality of a toothbrush is of great significance.

### SUMMARY

Embodiments of the present disclosure provide a method, an apparatus and a system for instructing tooth brushing, a processing device and a storage medium.

In one aspect, a method for instructing tooth brushing is provided. The method includes:

acquiring, during a tooth brushing process of an electric toothbrush based on a target tooth brushing solution, tooth brushing data collected by the electric toothbrush, wherein the tooth brushing data includes a tooth brushing duration and a tooth brushing pressure;

acquiring a tooth brushing evaluation result based on the tooth brushing data;

outputting the tooth brushing evaluation result; and

sending tooth brushing instruction information based on tooth brushing information, wherein the tooth brushing information includes: at least one of the tooth brushing evaluation result and the tooth brushing data, and the tooth brushing instruction information is configured to instruct a user of the electric toothbrush to brush teeth.

Optionally, the tooth brushing instruction information includes at least one of first adjustment indication information of an effective tooth brushing duration and second adjustment indication information of the tooth brushing pressure, wherein the effective tooth brushing duration is a length of time where the tooth brushing pressure is greater than a pressure threshold.

Optionally, the tooth brushing evaluation result includes at least one of a tooth brushing duration score and a tooth brushing pressure score.

Optionally, in response to the tooth brushing evaluation result including the tooth brushing duration score, acquiring the tooth brushing evaluation result based on the tooth brushing data includes:

acquiring, based on the tooth brushing duration and the tooth brushing pressure, an effective tooth brushing duration, wherein the effective tooth brushing duration is a length of time where the tooth brushing pressure is greater than a pressure threshold;

determining, in response to the effective tooth brushing duration being less than a first duration threshold, the tooth brushing duration score as a first preset score;

determining, in response to the effective tooth brushing duration being greater than or equal to a second duration threshold, the tooth brushing duration score as a second preset score, wherein the second duration threshold is determined based on a total tooth brushing duration of the target tooth brushing solution; and

determining, in response to the effective tooth brushing duration being less than the second duration threshold and greater than or equal to the first duration threshold, the tooth brushing duration score as a product of the second preset score and a target ratio, wherein the target ratio is a ratio of the effective tooth brushing duration to the second duration threshold.

Optionally, in response to the tooth brushing evaluation result including the tooth brushing pressure score, acquiring the tooth brushing evaluation result based on the tooth brushing data includes:

acquiring, based on the tooth brushing pressure and the tooth brushing duration, a plurality of duration proportions one-to-one corresponding to a plurality of preset pressure ranges, wherein the duration proportion is a ratio of a duration of the tooth brushing pressure in a corresponding preset pressure range to the tooth brushing duration;

determining, in response to a duration proportion corresponding to a first preset pressure range being greater than or equal to a proportion threshold, the tooth brushing pressure score as a first preset score; and

determining, in response to the duration proportion corresponding to the first preset pressure range being less than the proportion threshold, the tooth brushing pressure score as a difference between the second preset score and an ineffective tooth brushing score, wherein the ineffective tooth brushing score is a sum of ineffective scores of preset pressure ranges other than a second preset pressure range, and the ineffective score of the preset pressure range is a product of a corresponding duration proportion and a corresponding weight coefficient.

Optionally, the tooth brushing evaluation result further includes an average tooth brushing score, and acquiring the tooth brushing evaluation result based on the tooth brushing data includes:

calculating a weighted average of the tooth brushing duration score and the tooth brushing pressure score to acquire the average tooth brushing score.

Optionally, sending the tooth brushing instruction information based on the tooth brushing information includes:

inquiring, based on the tooth brushing information, a corresponding relationship between the tooth brushing information and the tooth brushing instruction information, and sending the inquired tooth brushing instruction information.

Optionally, prior to acquiring the tooth brushing data collected by the electric toothbrush, the method further includes:

acquiring user information of the user of the electric toothbrush, wherein the user information includes at least one of age, gender, a tooth health condition, a gum health condition, a tooth color, a dietary habit, tooth filling or not, a user of a dental brace or not, pregnancy or not, a new user of the electric toothbrush or not, a tooth brushing habit and a care need; and

recommending a tooth brushing solution to the user of the electric toothbrush based on the user information.

Optionally, recommending the tooth brushing solution to the user of the electric toothbrush based on the user information includes:

recommending, by using a tooth brushing solution recommendation algorithm, the tooth brushing solution to the user of the electric toothbrush based on the user information;

wherein the tooth brushing solution recommendation algorithm includes at least one of a rule-based recommendation algorithm, a collaborative filtering recommendation algorithm, and a demographic information-based recommendation algorithm.

In another aspect, an apparatus for instructing tooth brushing is provided. The apparatus includes:

a data collecting module, configured to acquire, during a tooth brushing process of an electric toothbrush based on a target tooth brushing solution, tooth brushing data collected by the electric toothbrush, wherein the tooth brushing data includes: a tooth brushing duration and a tooth brushing pressure;

an evaluating module, configured to acquire a tooth brushing evaluation result based on the tooth brushing data;

an outputting module, configured to output the tooth brushing evaluation result; and

a sending module, configured to send tooth brushing instruction information based on tooth brushing information, wherein the tooth brushing information includes at least one of the tooth brushing evaluation result and the tooth brushing data, and the tooth brushing instruction information is configured to instruct a user of the electric toothbrush to brush teeth.

Optionally, the tooth brushing instruction information includes at least one of first adjustment indication information of an effective tooth brushing duration and second adjustment indication information of the tooth brushing pressure, wherein the effective tooth brushing duration is a length of time where the tooth brushing pressure is greater than a pressure threshold.

Optionally, the tooth brushing evaluation result includes at least one of a tooth brushing duration score and a tooth brushing pressure score.

Optionally, in the case that the tooth brushing evaluation result includes the tooth brushing duration score, the evaluating module is configured to: acquire, based on the tooth brushing duration and the tooth brushing pressure, an effective tooth brushing duration, wherein the effective tooth brushing duration is a length of time where the tooth brushing pressure is greater than a pressure threshold; determine, in response to the effective tooth brushing duration being less than a first duration threshold, the tooth brushing duration score as a first preset score; determine, in response to the effective tooth brushing duration being greater than or equal to a second duration threshold, the tooth brushing duration score as a second preset score, wherein the second duration threshold is determined based on a total tooth brushing duration of the target tooth brushing solution; and determine, in response to the effective tooth brushing duration being less than the second duration threshold and greater than or equal to the first duration threshold, the tooth brushing duration score as a product of the second preset score and a target ratio, wherein the target ratio is a ratio of the effective tooth brushing duration to the second duration threshold.

Optionally, in the case that the tooth brushing evaluation result includes the tooth brushing pressure score, the evaluating module is configured to: acquire, based on the tooth brushing pressure and the tooth brushing duration, a plurality of duration proportions one-to-one corresponding to a plurality of preset pressure ranges, wherein the duration proportion is a ratio of a duration of the tooth brushing pressure in a corresponding preset pressure range to the tooth brushing duration; determine, in response to a duration proportion corresponding to a first preset pressure range being greater than or equal to a proportion threshold, the tooth brushing pressure score as the first preset score; and determine, in response to the duration proportion corresponding to the first preset pressure range being less than the proportion threshold, the tooth brushing pressure score as a difference between the second preset score and an ineffective tooth brushing score, wherein the ineffective tooth brushing score is a sum of ineffective scores of preset pressure ranges other than a second preset pressure range, and the ineffective score of the preset pressure range is a product of a corresponding duration proportion and a corresponding weight coefficient.

Optionally, the tooth brushing evaluation result further includes: an average tooth brushing score, and the evaluating module is configured to calculate a weighted average of the tooth brushing duration score and the tooth brushing pressure score to acquire the average tooth brushing score.

Optionally, the sending module is configured to: inquire, based on the tooth brushing information, a corresponding relationship between the tooth brushing information and the tooth brushing instruction information, and send the inquired tooth brushing instruction information.

Optionally, the apparatus further includes:

an information collecting module, configured to acquire user information of the user of the electric toothbrush, wherein the user information includes at least one of age, gender, a tooth health condition, a gum health condition, a tooth color, a dietary habit, tooth filling or not, a user of a dental brace or not, pregnancy or not, a new user of the electric toothbrush or not, a tooth brushing habit and a care need; and

a solution recommending module, configured to recommend a tooth brushing solution to the user of the electric toothbrush based on the user information.

Optionally, the solution recommending module is configured to: recommend, by using a tooth brushing solution recommendation algorithm, the tooth brushing solution to the user of the electric toothbrush based on the user information; wherein the tooth brushing solution recommendation algorithm includes at least one of a rule-based recommendation algorithm, a collaborative filtering recommendation algorithm, and a demographic information-based recommendation algorithm.

In yet another aspect, a processing device is provided. The processing device includes a processor, and a memory configured to store one or more instructions executable by the processor; wherein the processor, when loading and executing the one or more instructions, is caused to perform the method for instructing tooth brushing as described above.

In still a further aspect, a system for instructing tooth brushing is provided. The system for instructing tooth brushing includes an electric toothbrush, and a processing device communicatively connected to the electric toothbrush, wherein the processing device is the processing device as described above.

Optionally, the processing device is a server, and the system for instructing tooth brushing further includes a terminal, wherein the terminal is communicatively connected to the electric toothbrush and the server;

the terminal is configured to: receive tooth brushing data collected by the electric toothbrush, and send the tooth brushing data to the server; and

the terminal is further configured to receive and display a tooth brushing evaluation result and tooth brushing instruction information sent by the server.

In still yet another aspect, a computer-readable storage medium storing one or more instructions therein is provided. The readable storage medium, when running on a processing component, causes the processing component to perform the method for instructing tooth brushing as described above.

### BRIEF DESCRIPTION OF THE DRAWINGS

FIG. 1 is a schematic structural diagram of a system for instructing tooth brushing involved in a method for instructing tooth brushing according to an embodiment of the present disclosure;

FIG. 2 is a flowchart of a method for instructing tooth brushing according to an embodiment of the present disclosure;

FIG. 3 is a flowchart of another method for instructing tooth brushing according to an embodiment of the present disclosure;

FIG. 4 is a flowchart of acquiring a tooth brushing duration score according to an embodiment of the present disclosure;

FIG. 5 is a flowchart of acquiring a tooth brushing pressure score according to an embodiment of the present disclosure;

FIG. 6 is an effect diagram of displaying a tooth brushing evaluation result on a display screen of a terminal according to an embodiment of the present disclosure;

FIG. 7 is a structural block diagram of an apparatus for instructing tooth brushing according to an embodiment of the present disclosure;

FIG. 8 is a structural block diagram of another apparatus for instructing tooth brushing according to an embodiment of the present disclosure;

FIG. 9 is a schematic structural diagram of a processing device according to an embodiment of the present disclosure; and

FIG. 10 is a schematic structural diagram of another system for instructing tooth brushing according to an embodiment of the present disclosure.

### DETAILED DESCRIPTION

For clearer descriptions of the objectives, technical solutions, and advantages of the present disclosure, embodiments of the present disclosure are described in detail hereinafter with reference to the accompanying drawings.

At present, most users do not have a clear understanding of a tooth brushing method. They often have problems that an effective length of tooth brushing is too short, a tooth brushing pressure is lower, the tooth brushing pressure is higher and the like during the tooth brushing process. In order to assist the users to develop a good tooth brushing habit, at present, a tooth brushing solution is usually recommended to the users over terminal devices such as TVs or mobile phones. However, since most users have not received professional tooth brushing instructions, it is difficult to practice the recommended tooth brushing solution with a higher standard in the tooth brushing process, and a tooth brushing effect of the recommended tooth brushing solution cannot be achieved.

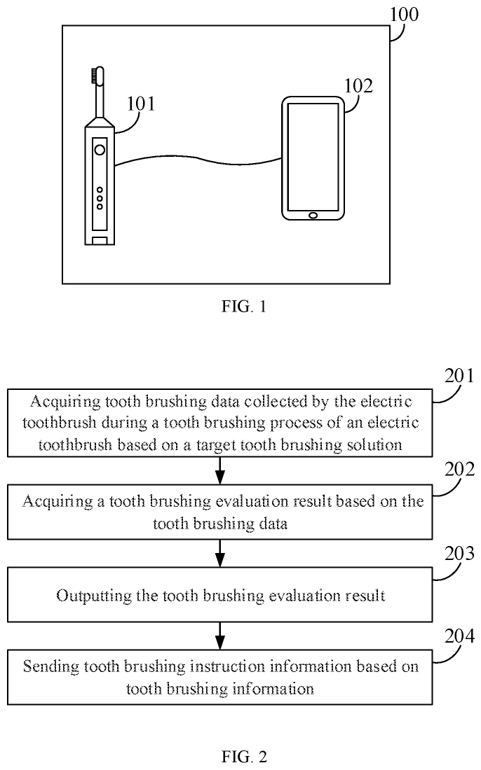

FIG. 1 is a schematic structural diagram of a system for instructing tooth brushing involved in a method for instructing tooth brushing according to an embodiment of the present disclosure. The system for instructing tooth brushing 100 may include an electric toothbrush 101 and a processing device 102. The electric toothbrush 101 may be communicatively connected to the processing device 102.

In a possible embodiment, the processing device 102 may be a terminal such as a TV, a mobile phone, a tablet computer, a desktop computer, or a wearable device. In this case, the processing device 102 may be communicatively connected to the electric toothbrush 101 through a wireless network such as Bluetooth or wireless fidelity (WIFI).

In another possible embodiment, the processing device 102 may be a server, or a server cluster including several servers, or a cloud computing service center. In this case, the processing device 102 may establish the communication connection with the electric toothbrush 102 through a terminal. For example, the terminal may be communicatively connected to the electric toothbrush 101 through the wireless network such as Bluetooth or WIFI, and the terminal may also be communicatively connected to the processing device 102 through the wireless network.

FIG. 2 is a flowchart of a method for instructing tooth brushing according to an embodiment of the present disclosure. The method for instructing tooth brushing is applicable to the processing device 102 in the system for instructing tooth brushing 100 shown in FIG. 1. The method for instructing tooth brushing includes the following steps.

In 201, during a tooth brushing process of an electric toothbrush based on a target tooth brushing solution, tooth brushing data collected by the electric toothbrush is acquired.

The tooth brushing data may include a tooth brushing duration and a tooth brushing pressure.

In 202, a tooth brushing evaluation result is acquired based on the tooth brushing data.

In 203, the tooth brushing evaluation result is output.

In 204, tooth brushing instruction information is sent based on tooth brushing information.

The tooth brushing information includes at least one of the tooth brushing evaluation result and the tooth brushing data. The tooth brushing instruction information is configured to instruct a user of the electric toothbrush to brush teeth.

In summary, in the method for instructing tooth brushing according to the embodiment of the present disclosure, the tooth brushing evaluation result of a tooth brushing process is obtained by acquiring the tooth brushing data collected during the tooth brushing process of the electric toothbrush based on the target tooth brushing solution. In addition, based on at least one of the tooth brushing data and the tooth brushing evaluation result, the tooth brushing instruction information for instructing the user of the electric toothbrush to brush teeth may be sent. In this way, the user of the electric toothbrush learns about a tooth brushing quality of the current tooth brushing process by checking the tooth brushing evaluation result. In the case that the tooth brushing quality of the current tooth brushing process is lower, the user of the electric toothbrush may improve the next tooth brushing process by checking the tooth brushing instruction information to improve the subsequent tooth brushing quality, such that the user of the electric toothbrush can practice the target tooth brushing solution in a more standardized fashion in a subsequent tooth brushing process, and then can achieve a tooth brushing effect of the target tooth brushing solution.

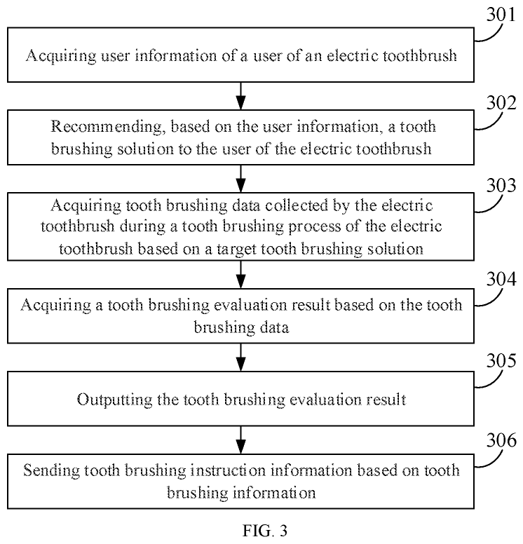

Please refer to FIG. 3, which is a flowchart of another method for instructing tooth brushing according to an embodiment of the present disclosure. The method for instructing tooth brushing is applicable to the processing device 102 in the system for guiding tooth brushing 100 shown in FIG. 1. The method for instructing tooth brushing includes the following steps.

In 301, user information of a user of an electric toothbrush is acquired.

In the present disclosure, the processing device may acquire the user information of the user of the electric toothbrush. The user information includes at least one of age, gender, a dental health condition, a gum health condition, a tooth color, a dietary habit, tooth filling or not, a user of a dental brace or not, pregnancy or not, a new user of an electric toothbrush or not, a tooth brushing habit, and a care need. The dental health condition may include a firmness degree of teeth, a looseness degree of the teeth, having fragile teeth or not, having decayed teeth or not, and the like. The gum health condition may include having an easily bleeding gum or not, having a red and swollen gum or not, and the like. The eating habit may include a preference for smoking or not, a preference for desserts and midnight snacks or not, a preference for drinking tea, red wine, colored beverages, and coffee or not, and the like. The care need may include a cleaning care, a whitening care, a sensitive care, and the like.

Exemplarily, in the case that the processing device is a terminal, the user of the electric toothbrush may directly fill in the above user information on the terminal. In the case that the processing device is a server, the user of the electric toothbrush requires to firstly fill in the above user information on the terminal communicatively connected to the electric toothbrush, and then the terminal requires to send the user information to the server.

In 302, a tooth brushing solution is recommended to the user of the electric toothbrush based on the user information.

In the embodiment of the present disclosure, in response to acquiring the user information, the processing device may recommend the tooth brushing solution to the user of the electric toothbrush based on the user information. The tooth brushing solution may include tooth brushing steps, a duration of each tooth brushing step, a tooth brushing region, a tooth brushing mode, a tooth brushing gear, and the like. It should be noted that the tooth brushing mode mainly refers to a vibration mode of the electric toothbrush and a vibration frequency of the electric toothbrush. The tooth brushing gear mainly refers to a vibration intensity of the electric toothbrush.

Optionally, 302 may include: by the processing device, recommending, by using a tooth brushing solution recommendation algorithm, the tooth brushing solution to the user of the electric toothbrush based on the user information. The tooth brushing solution recommendation algorithm includes at least one of a rule-based recommendation algorithm, a collaborative filtering recommendation algorithm, and a demographic information-based recommendation algorithm. Exemplarily, recommending, by the processing device, the tooth brushing solution to the user of the electric toothbrush may include the following nine cases.

In a first case, in response to determining that the user of the electric toothbrush is a new user of the electric toothbrush based on the user information, the processing device may recommend an initial cleaning solution to the user of the electric toothbrush. It should be noted that in the case that, the user of the electric toothbrush brushes the teeth for multiple times based on the initial cleaning solution and can adapt to the initial cleaning solution, the processing device may recommend other tooth brushing solutions to the user of the electric toothbrush. Content of the initial cleaning solution may be referred to the following Table 1.

TABLE 1

| Tooth | Tooth | Tooth | Tooth | Tooth |
|---|---|---|---|---|
| brushing | brushing | brushing | brushing | brushing |
| step | duration | region | mode | gear |
| First step | 0:00-0:30 | Outer side of | Cleaning | 1 |
| | | left teeth | | |
| Second step | 0:30-1:00 | Outer side of | Cleaning | 1 |
| | | right teeth | | |
| Third step | 1:00-1:30 | Inner side of | Cleaning | 1 |
| | | right teeth | | |
| Fourth step | 1:30-2:00 | Inner side of | Cleaning | 1 |
| | | left teeth | | |

In a second case, in response to determining that the user of the electric toothbrush is a user having firm and yellowish teeth, not a new user of the electric toothbrush, and having a need for a cleaning care based on the user information, the processing device may recommend a standard cleaning solution to the user of the electric toothbrush. In the case that the standard cleaning solution is adopted for tooth brushing, tooth gaps may be effectively cleaned, and dental plaque may be effectively removed. Content of the standard cleaning solution may be referred to the following Table 2.

TABLE 2

| Tooth | Tooth | Tooth | Tooth | Tooth |
|---|---|---|---|---|
| brushing | brushing | brushing | brushing | brushing |
| step | duration | region | mode | gear |
| First step | 0:00-0:30 | Outer side of | Cleaning | 2 |
| | | left teeth | | |
| Second step | 0:30-1:00 | Outer side of | Cleaning | 2 |
| | | right teeth | | |
| Third step | 1:00-1:30 | Inner side of | Cleaning | 2 |
| | | right teeth | | |
| Fourth step | 1:30-2:00 | Inner side of | Cleaning | 2 |
| | | left teeth | | |

In a third case, in response to determining that the user of the electric toothbrush is a user having firm teeth and no missing teeth, not a new user of the electric toothbrush, and having no tooth filling, no pregnancy and having a need for a cleaning care based on the user information, the processing device may recommend a super cleaning solution to the user of the electric toothbrush. In the case that the super cleaning solution is adopted for tooth brushing, the tooth gaps may be further cleaned, and the dental plaque may be further removed. Content of the super cleaning solution may be referred to the following Table 3.

TABLE 3

| Tooth | Tooth | Tooth | Tooth | Tooth |
|---|---|---|---|---|
| brushing | brushing | brushing | brushing | brushing |
| step | duration | region | mode | gear |
| First step | 0:00-0:30 | Outer side of | Cleaning | 4 |
| | | left teeth | | |
| Second step | 0:30-1:00 | Outer side of | Cleaning | 4 |
| | | right teeth | | |
| Third step | 1:00-1:30 | Inner side of | Cleaning | 4 |
| | | right teeth | | |
| Fourth step | 1:30-2:00 | Inner side of | Cleaning | 4 |
| | | left teeth | | |

In a fourth case, in response to determining that the user of the electric toothbrush is a user having firm and yellowish teeth and liking to drink coffee, red wine and tea based on the user information, the processing device may recommend a standard whitening solution to the user of the electric toothbrush. The standard whitening solution can increase tooth whitening time on the basis of the standard cleaning solution, which effectively improves a tooth whitening effect. Content of the standard dazzling white solution may be referred to the following Table 4.

TABLE 4

| Tooth | Tooth | Tooth | Tooth | Tooth |
|---|---|---|---|---|
| brushing | brushing | brushing | brushing | brushing |
| step | duration | region | mode | gear |
| First step | 0:00-0:30 | Outer side of | Cleaning | 2 |
| | | left teeth | | |
| Second step | 0:30-1:00 | Outer side of | Cleaning | 2 |
| | | right teeth | | |
| Third step | 1:00-1:30 | Inner side of | Cleaning | 2 |
| | | right teeth | | |
| Fourth step | 1:30-2:00 | Inner side of | Cleaning | 2 |
| | | left teeth | | |
| Fifth step | 2:00-2:30 | Customized | Whitening | 3 |
| | | region | | |

In a fifth case, in response to determining that the user of the electric toothbrush is a user having firm and yellowish teeth, using the electric toothbrush for a long time, and having a need for a whitening care based on the user information, the processing device may recommend a super whitening solution to the user of the electric toothbrush. In the case that the super whitening solution is adopted for tooth brushing, the teeth may be deeply polished, and a whitening degree of the teeth may be improved. Content of the super whitening solution may be referred to the following Table 5.

TABLE 5

| Tooth | Tooth | Tooth | Tooth | Tooth |
|---|---|---|---|---|
| brushing | brushing | brushing | brushing | brushing |
| step | duration | region | mode | gear |
| First step | 0:00-0:30 | Outer side of | Whitening | 4 |
| | | left teeth and | | |
| | | outer side of | | |
| | | right teeth | | |
| Second step | 0:30-1:00 | Inner side of | Whitening | 4 |
| | | right teeth and | | |
| | | inner side of | | |
| | | left teeth | | |
| Third step | 1:00-1:30 | Outer side of | Cleaning | 4 |
| | | left teeth and | | |
| | | outer side of | | |
| | | right teeth | | |
| Fourth step | 1:30-2:00 | Inner side of | Cleaning | 4 |
| | | right teeth and | | |
| | | inner side of | | |
| | | left teeth | | |

In a sixth case, in response to determining that the user of the electric toothbrush is a user with loose teeth, a red and swollen gum and having a need for a sensitive care based on the user information, the processing device may recommend a sensitive care solution to the user of the electric toothbrush. In the case that the sensitive care solution is adopted for tooth brushing, the teeth may be brushed lightly, and the gum may be massaged, thereby caring for the health of the gum and avoiding gum bleeding. Content of the sensitive care solution may be referred to the following Table 6.

TABLE 6

| Tooth | Tooth | Tooth | Tooth | Tooth |
|---|---|---|---|---|
| brushing | brushing | brushing | brushing | brushing |
| step | duration | region | mode | gear |
| First step | 0:00-0:30 | Outer side of | Cleaning | 1 |
| | | left teeth | | |
| Second step | 0:30-1:00 | Outer side of | Cleaning | 1 |
| | | right teeth | | |
| Third step | 1:00-1:30 | Inner side of | Cleaning | 1 |
| | | right teeth | | |
| Fourth step | 1:30-2:00 | Inner side of | Cleaning | 1 |
| | | left teeth | | |
| Fifth step | 2:00-2:30 | Gum | Massaging | 1 |

In a seventh case, in response to determining that the user of the electric toothbrush is a user of a dental brace based on the user information, the processing device may recommend a special care solution to the user of the electric toothbrush. In the case that the special care solution is adopted for tooth brushing, the teeth may be brushed lightly with a longer cleaning time, a tooth surface of each tooth of the user using the dental brace may be brushed thoroughly, and food residues can be avoided. Content of the special care solution may be referred to the following Table 7.

TABLE 7

| Tooth | Tooth | Tooth | Tooth | Tooth |
|---|---|---|---|---|
| brushing | brushing | brushing | brushing | brushing |
| step | duration | region | mode | gear |
| First step | 0:00-1:00 | Outer side of | Cleaning | 1 |
| | | left teeth | | |
| Second step | 1:00-2:00 | Outer side of | Cleaning | 1 |
| | | right teeth | | |
| Third step | 2:00-3:00 | Inner side of | Cleaning | 1 |
| | | right teeth | | |
| Fourth step | 4:00-4:00 | Inner side of | Cleaning | 1 |
| | | left teeth | | |

In an eighth case, in response to determining that the user of the electric toothbrush is a user liking to drink coffee, red wine, tea or colored beverages and liking to eat desserts or midnight snacks based on the user information, the processing device may recommend a dessert and beverage cleaning solution to the user of the electric toothbrush. In the case that the dessert and beverage cleaning solution is adopted for tooth brushing, the teeth may be effectively cleaned and whitened. Content of the dessert and beverage cleaning solution may be referred to the following Table 8.

TABLE 8

| Tooth | Tooth | Tooth | Tooth | Tooth |
|---|---|---|---|---|
| brushing | brushing | brushing | brushing | brushing |
| step | duration | region | mode | gear |
| First step | 0:00-1:00 | Outer side of | Whitening | 2 |
| | | left teeth and | | |
| | | outer side of | | |
| | | right teeth | | |
| Second step | 1:00-2:00 | Inner side of | Whitening | 2 |
| | | right teeth and | | |
| | | inner side of | | |
| | | left teeth | | |
| Third step | 2:00-3:00 | Outer side of | Cleaning | 2 |
| | | left teeth and | | |
| | | outer side of | | |
| | | right teeth | | |
| Fourth step | 4:00-4:00 | Inner side of | Cleaning | 2 |
| | | right teeth and | | |
| | | inner side of | | |
| | | left teeth | | |

In a ninth case, in response to determining that the user of the electric toothbrush is a pregnant woman based on the user information, the processing device may recommend a pregnancy gum-protecting cleaning solution to the user of the electric toothbrush. In the case that the pregnancy gum-protecting cleaning solution is adopted for tooth brushing, a standard cleaning combined with a certain period of gentle massage of the gum may have a strengthening effect on the gum and prevent the problem of gum bleeding. Content of the pregnancy gum-protecting cleaning solution may be referred to the following Table 9.

TABLE 9

| Tooth | Tooth | Tooth | Tooth | Tooth |
|---|---|---|---|---|
| brushing | brushing | brushing | brushing | brushing |
| step | duration | region | mode | gear |
| First step | 0:00-0:30 | Outer side of | Cleaning | 2 |
| | | left teeth | | |
| Second step | 0:30-1:00 | Outer side of | Cleaning | 2 |
| | | right teeth | | |
| Third step | 1:00-1:30 | Inner side of | Cleaning | 2 |
| | | right teeth | | |
| Fourth step | 1:30-2:00 | Inner side of | Cleaning | 2 |
| | | left teeth | | |
| Fifth step | 2:00-3:00 | Gum | Massaging | 2 |

According to the above nine cases, it can be seen that the processing device may acquire the user information and recommend the tooth brushing solution suitable for the user's own situation to the user of the electric toothbrush based on the user information, such that the user of the electric toothbrush can improve the tooth brushing effect in the case of brushing the teeth based on the recommended tooth brushing solution.

It should be noted that in the case that the processing device recommends the tooth brushing solution to the user of the electric toothbrush, the processing device may determine the recommended tooth brushing solution as a target tooth brushing solution, and control the electric toothbrush for tooth brushing based on the target tooth brushing solution. The user of the electric toothbrush may also customize the tooth brushing solution according to the user's own preferences. In this case, the processing device may determine the customized tooth brushing solution as the target tooth brushing solution, and control the electric toothbrush to brush based on the target tooth brushing solution, which is not limited by the embodiments of the present disclosure.

It should also be noted that the processing device may output tooth brushing guidance information with the electric toothbrush brushing based on the target tooth brushing solution simultaneously. The tooth brushing guidance information is configured to guide the user of the electric toothbrush to brush during a tooth brushing process, such that the user of the electric toothbrush may more accurately brush the teeth based on the target tooth brushing solution, thereby improving the tooth brushing effect. The embodiment of the present disclosure schematically illustrates the tooth brushing guidance information output by the processing device with the following two optional embodiments.

In a first optional embodiment, the tooth brushing guidance information output by the processing device may be literal information or video information, which may be displayed on a display screen of the terminal.

In a second optional embodiment, the electric toothbrush includes an audio play component, and the tooth brushing guidance information may be audio information. In this way, the processing device may send the tooth brushing guidance information to the electric toothbrush, such that the electric toothbrush may synchronously play the tooth brushing guidance information based on the target solution during the tooth brushing process.

In 303, during the tooth brushing process of the electric toothbrush based on the target tooth brushing solution, tooth brushing data collected by the electric toothbrush is acquired.

In the embodiment of the present disclosure, during the tooth brushing process of the electric toothbrush tooth based on the target tooth brushing solution, the electric toothbrush may collect the tooth brushing data. Afterwards, the electric toothbrush may send the collected tooth brushing data to the processing device, such that the processing device may acquire the tooth brushing data collected by the electric toothbrush. The tooth brushing data may include a tooth brushing duration and a tooth brushing pressure.

Exemplarily, in the case that the processing device is a terminal, since the terminal is communicatively connected to the electric toothbrush, the processing device may directly acquire the tooth brushing data collected by the electric toothbrush. In the case that the processing device is a server, since the server requires to be communicatively connected to the electric toothbrush through the terminal, upon the collection of the tooth brushing data, the electric toothbrush may send the tooth brushing data to the terminal at first, and then the tooth brushing data may be sent to the server by the terminal.

The tooth brushing duration in the embodiment of the present disclosure refers to a total duration of current tooth brushing. In one case, during the tooth brushing process of the electric toothbrush based on the target solution, the user of the electric toothbrush may turn off the electric toothbrush by oneself. In this case, the tooth brushing duration is from the start to the end of working of the electric toothbrush. In another case, the user of the electric toothbrush does not turn off the electric toothbrush by oneself, and the electric toothbrush is automatically turned off in the case of continuously working for the total tooth brushing duration of the target tooth brushing solution. In this case, the tooth brushing duration is the total tooth brushing duration of the target tooth brushing solution. In this way, by combining the above two cases, the electric toothbrush may collect the tooth brushing duration in such a way that the electric toothbrush determines a working duration of the electric toothbrush during the tooth brushing process as the tooth brushing time length.

The tooth brushing pressure in the embodiment of the present disclosure refers to the size of a pressure exerted on the teeth by a brush head of the electric toothbrush during the tooth brushing process. During the tooth brushing process of the electric toothbrush based on the target solution, the size of an action force (that is, the tooth brushing pressure) of the brush head of the electric toothbrush on the teeth is the same as the size of a reaction force of the teeth on the brush head. In this way, the brush head of the electric toothbrush may include a pressure sensor, and the electric toothbrush may collect the tooth brushing pressure in such a way that the pressure sensor acquires the reaction force of the teeth on the brush head during the current tooth brushing process and determines the reaction force as the tooth brushing pressure.

Those skilled in the art may also acquire the tooth brushing duration and the tooth brushing pressure in other ways, which is not limited by the embodiment of the present disclosure as long as the tooth brushing duration and the tooth brushing pressure can be acquired.

In 304, a tooth brushing evaluation result is acquired based on the tooth brushing data.

In the embodiment of the present disclosure, in response to acquiring the tooth brushing data collected by the electric toothbrush, the processing device may acquire the tooth brushing evaluation result based on the tooth brushing data.

Optionally, the tooth brushing evaluation result may include at least one of a tooth brushing duration score and a tooth brushing pressure score. The following embodiments illustrate the fashion in which the tooth brushing evaluation result is acquired by the processing device in two cases of acquiring the tooth brushing duration score and the tooth brushing pressure score respectively.

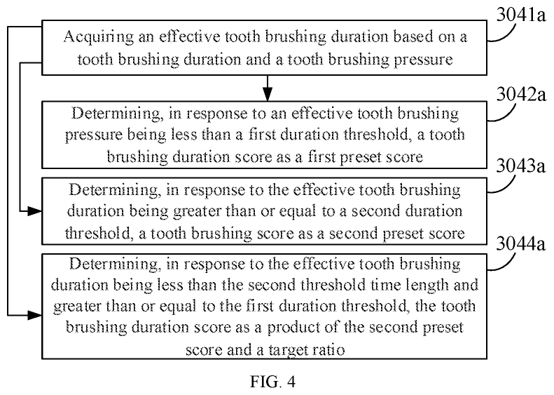

In a first case, in the case that the tooth brushing evaluation result includes the tooth brushing duration score, referring to FIG. 4 which is a flowchart of acquiring the tooth brushing duration score according to an embodiment of the present disclosure, acquiring the tooth brushing duration score may include the following steps.

In 3041a, an effective tooth brushing duration is acquired based on the tooth brushing duration and the tooth brushing pressure.

The effective tooth brushing duration is a length of time where the tooth brushing pressure is greater than a pressure threshold. Exemplarily, the pressure threshold may be a pressure in the case that the brush head of the electric toothbrush is in contact with the teeth (that is, in the case that the electric toothbrush is idling). For example, the pressure threshold may usually be 0. In this way, the effective tooth brushing duration is a difference between the tooth brushing duration and the length of time in the case that the electric tooth is idling.

In the embodiment of the present disclosure, in response to acquiring the tooth brushing data collected by the electric toothbrush by the processing device, the processing device may acquire the duration of each tooth brushing pressure. In this way, in a possible embodiment, the processing device may count a first total duration that the tooth brushing pressure is greater than the pressure threshold, and determine the first total duration as the effective tooth brushing duration. In another possible embodiment, the processing device may count a second total duration that the tooth brushing pressure is less than or equal to the pressure threshold. The second total duration is the duration that the electric toothbrush is idling, and then the difference between the tooth brushing duration and the second total duration is determined as the effective tooth brushing duration.

In 3042a, in response to an effective tooth brushing pressure being less than a first duration threshold, it is determined that the tooth brushing duration score is a first preset score.

Exemplarily, the first duration threshold may be 15 seconds, and the first preset score may be 0. That is, in the case that the processing device determines that the effective tooth brushing duration is less than the first duration threshold, the processing device determines an idle time of the electric toothbrush during the tooth brushing process, determines that the tooth brushing is ineffective, and determines the tooth brushing duration score of the tooth brushing to be 0.

In 3043a, in response to the effective tooth brushing duration being greater than or equal to a second duration threshold, the tooth brushing score is determined as a second preset score.

Exemplarily, the second preset score is a full score. For example, the second preset score may be 100. The second duration threshold is determined based on the total tooth brushing duration of the target tooth brushing solution.

In the present disclosure, during the tooth brushing process of the electric toothbrush based on the target tooth brushing solution, as the user of the electric toothbrush switches a tooth brushing position, the electric toothbrush is in an idling state during the switching of the brushing position. Therefore, an ineffective tooth brushing duration is allowed during the tooth brushing process of the electric toothbrush based on the target tooth brushing solution. The ineffective tooth brushing duration is a total duration of switching the tooth brushing position during the tooth brushing process, and is usually counted based on tooth brushing experience, and is a fixed value. For example, the ineffective tooth brushing duration may be 10 seconds. In this case, the difference between the total tooth brushing duration of the target tooth brushing solution and the ineffective tooth brushing duration may be determined as the second duration threshold. In this way, in response to determining that the effective tooth brushing duration is greater than or equal to the second duration threshold, the processing device determines that the tooth brushing duration score of the current tooth brushing is a full score.

In 3044a, in response to the effective tooth brushing duration being less than the second duration threshold and greater than or equal to the first duration threshold, the tooth brushing duration score is determined as a product of the second preset score and a target ratio.

The target ratio is a ratio of the effective tooth brushing duration to the second duration threshold.

In the present disclosure, since the second preset score is the full score, in the case where the processing device determines that the effective tooth brushing duration is less than the second duration threshold and greater than or equal to the first duration threshold, the processing device may determine the product of the target ratio and the full score as the tooth brushing duration score of the current tooth brushing.

In combination with 3041a and 3044a, it is assumed that the first preset score is 0, the second preset score is 100, the first duration threshold is 15 seconds, and the ineffective tooth brushing duration allowed in the tooth brushing process is 10 seconds. Then, a relationship between the tooth brushing duration scored(T), the total duration Tt of the target tooth brushing solution and the effective tooth brushing duration Tu is as follows:

$$\{ \begin{matrix}score ( T ) = 0 ; ( Tu < 15 ) \\ score ( T ) = 100 ; ( Tu \geq Tt - 10 ) \\ score ( T ) = 100 \times \frac{T u}{Tt - 10} ; ( 15 \leq T u < T t - 10 )\end{matrix} .$$

It should be noted that Tt-10 in the above formula is the second duration threshold. Generally, it takes more than 120 seconds to achieve a better tooth brushing effect in tooth brushing. Therefore, in the case that the total duration of the target tooth brushing solution is less than 120 seconds, the second duration threshold is 120−10=110 seconds.

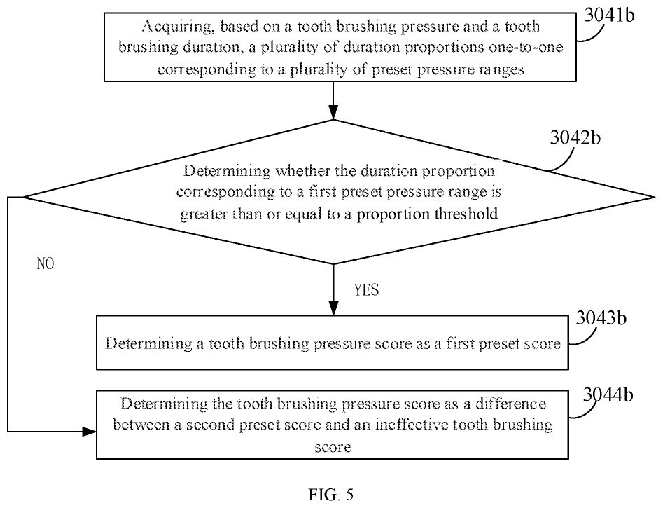

In a second case, in the case that the tooth brushing evaluation result includes a tooth brushing pressure score, referring to FIG. 5 which is a flowchart for acquiring the tooth brushing pressure score according to an embodiment of the present disclosure, acquiring the tooth brushing pressure score may include the following steps.

In 3041b, a plurality of duration proportions one-to-one corresponding to a plurality of preset pressure ranges are acquired based on the tooth brushing pressure and the tooth brushing duration.

The duration proportion is a ratio of the duration of the tooth brushing pressure in a corresponding preset pressure range to the tooth brushing duration.

Exemplarily, the various preset pressure ranges in the embodiment of the present disclosure may be determined based on different pressures exerted to the teeth during the tooth brushing process. For example, the plurality of preset pressure ranges may be respectively: a pressure range of toothbrush idling, a pressure range of a lower tooth brushing pressure, a pressure range of a standard tooth brushing pressure, a pressure range of a large tooth brushing pressure, and a pressure range of a higher tooth brushing pressure. The plurality of preset pressure ranges are as shown in the following Table 10.

TABLE 10

| Pressure range | Pressure size (N) |
|---|---|
| Toothbrush idling | 0 |
| Lower tooth brushing | (0N, 1.5N) |
| pressure | |
| Standard tooth brushing | [1.5N, 2.5N] |
| pressure | |
| High tooth brushing pressure | (2.5N, 3N] |
| Higher tooth brushing | (3N, +∞) |
| pressure | |

Based on Table 10, it can be seen that the pressure range of toothbrush idling is: [0]; the pressure range of the lower tooth brushing pressure is: (0N, 1.5N), the pressure range of the standard tooth brushing pressure is: [1.5N, 2.5N]; the pressure range of the large tooth brushing pressure is (2.5N, 3N); and the pressure range of the higher tooth brushing pressure is (3N, +∞), In this way, in 3041b; the plurality of duration proportions one-to-one corresponding to the plurality of preset pressure ranges are acquired, that is: a ratio of the duration of the tooth brushing pressure equal to 0 to the tooth brushing duration, a ratio of the duration of the tooth brushing pressure greater than 0 and less than 1.5N to the tooth brushing duration, a ratio of the duration of the tooth brushing pressure greater than or equal to 1.5N and less than or equal to 2.5N to the tooth brushing duration, a ratio of the duration of the tooth brushing pressure greater than 2.5N and less than or equal to 3N to the tooth brushing duration; and a ratio of the duration of the tooth brushing pressure greater than 3N to the tooth brushing duration.

In 3042b, whether the time length proportion corresponding to a first preset pressure range is greater than or equal to a proportion threshold is determined.

Exemplarily, the first preset pressure range may be the pressure range of toothbrush idling. The proportion threshold may be 85%.

In the present disclosure, in the case that the processing device determines that the duration proportion corresponding to the first preset pressure range is greater than or equal to the proportion threshold. 3043b is performed. In the case that the processing device determines that the duration proportion corresponding to the first preset pressure range is less than the proportion threshold, 3044b is performed.

In 3043b, the tooth brushing pressure score is determined as the first preset score.

Exemplarily, the first preset score may be 0. That is, in the case that the processing device determines that the duration proportion corresponding to the first preset pressure range is greater than or equal to the proportion threshold, the processing device determines an idling process of the electric toothbrush during the current tooth brushing process, determines that the tooth brushing is ineffective, and determines the tooth brushing pressure score as 0.

In 3044b, the tooth brushing pressure score is determined as a difference between the second preset score and the ineffective tooth brushing score.

The ineffective tooth brushing score is a sum of ineffective scores of each of preset pressure ranges in the plurality of preset pressure ranges other than the second preset pressure range, and the ineffective score of the preset pressure range is a product of a corresponding duration proportion and a corresponding weight coefficient.

Exemplarily, the second preset score is a full score. For example, the second preset score may be 100. The second preset pressure range may be the pressure range of the standard tooth brushing pressure. The plurality of preset pressure ranges other than the second preset pressure range are respectively the pressure range of toothbrush idling, the pressure range of the lower tooth brushing pressure, the pressure range of the high tooth brushing pressure, and the pressure range of the higher tooth brushing pressure.

It is assumed that the duration proportion corresponding to the pressure range of toothbrush idling is Q1, and the corresponding weight coefficient is 100; the duration proportion corresponding to the pressure range of the lower tooth brushing pressure is Q2, and the corresponding weight coefficient is 10; the duration proportion corresponding to the pressure range of the high tooth brushing pressure is Q3, and the corresponding weight coefficient is 10; the duration proportion corresponding to the pressure range of the higher tooth brushing pressure is Q4, and the corresponding weight coefficient is 50. Then, the ineffective tooth brushing score D satisfies the following formula:

D=100×Q1+10×Q2+10×Q3+50×Q4

In the present disclosure, since the second preset score is the full score, in the case that the processing device determines that the duration proportion corresponding to the first preset pressure range is less than the proportion threshold, the processing device may firstly determine the difference between the ineffective tooth brushing score and the full score as the tooth brushing pressure score of current tooth brushing.

In combination with 3041b and 3044b, it is assumed that the first preset score is 0, the second preset score is 100, and the proportion threshold is 85%. Then, a relationship between the tooth brushing pressure score(P), the duration proportion Q1 corresponding to the first preset pressure range (that is, the pressure range of toothbrush idling) and the ineffective tooth brushing score D is as follows:

$$\{ \begin{matrix}score ( P ) = 0 ; ( Q 1 \geq 85 \% ) \\ score ( P ) = 100 - D ; ( Tu < 85 \% )\end{matrix} .$$

In the embodiment of the present disclosure, the tooth brushing evaluation result may not only include at least one of the tooth brushing duration score and the tooth brushing pressure score, but also include an average tooth brushing score. In this case, in response to acquitting the tooth brushing duration score and the tooth brushing pressure in 304, the processing device may calculate a weighted average of the tooth brushing duration score and the tooth brushing pressure score to acquire the average tooth brushing score. Exemplarily, the average tooth brushing score is score=[score(T)+score(P)]/2.

In a possible embodiment, the processing device acquires the tooth brushing duration score, the tooth brushing pressure score, and the average tooth brushing score based on the tooth brushing data, and determines the tooth brushing duration score, the tooth brushing pressure score, and the average tooth brushing score as the tooth brushing evaluation result.

In 305, the tooth brushing evaluation result is output.

In the embodiment of the present disclosure, in response to acquiring the tooth brushing evaluation result, the processing device may output the tooth brushing evaluation result.

Exemplarily, in the case that the processing device is a terminal, the outputting tooth brushing evaluation result from the processing device refers to displaying the tooth brushing evaluation result on a display screen of the processing device. In the case that the processing device is a server, the outputting evaluation result from the processing device refers to sending the tooth brushing evaluation result to a terminal communicatively connected to the electric toothbrush, and displaying the tooth brushing evaluation result on a display screen of the terminal.

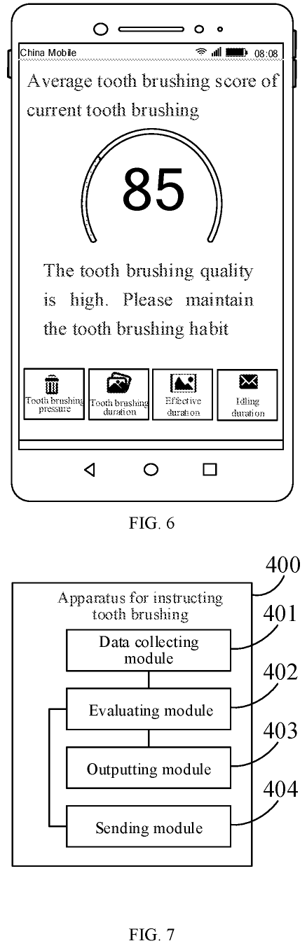

For example, FIG. 6 is an effect diagram of displaying the tooth brushing evaluation result on the display screen of the terminal according to an embodiment of the present disclosure. The tooth brushing evaluation result may be a tooth brushing score, and the tooth brushing score may include at least one of the tooth brushing duration score, the tooth brushing pressure score, and the average tooth brushing score. In actual use, in order to enable the user of the electric toothbrush to quickly understand a tooth brushing quality of the tooth brushing, only the average tooth brushing score may be displayed on the display screen of the terminal. For example, as shown in FIG. 6, the current tooth brushing score displayed on the display screen of the terminal is the average tooth brushing score, which is 85 points.

It should be noted that, as shown in FIG. 6, the display screen of the terminal may display not only the tooth brushing evaluation result, but also tooth brushing data. For example, at least one of the tooth brushing pressure, the tooth brushing duration, the effective tooth brushing duration, and an idling duration may be displayed.

In 306, tooth brushing instruction information is sent based on tooth brushing information.

The tooth brushing information may include at least one of the tooth brushing evaluation result and the tooth brushing data. In the embodiment of the present disclosure, in the case of the processing device acquiring the tooth brushing evaluation result, the processing device may send the tooth brushing instruction information based on at least one of the tooth brushing evaluation result and the tooth brushing data. The tooth brushing instruction information is configured to instruct the user of the electric toothbrush to brush teeth. In this way, the user of the electric toothbrush learns about a tooth brushing quality of the current tooth brushing process by checking the tooth brushing evaluation result. In the case that the tooth brushing quality of the current tooth brushing process is lower, the user of the electric toothbrush may improve the next tooth brushing process by checking the tooth brushing instruction information to improve the quality of the subsequent tooth brushing. The embodiment of the present disclosure schematically illustrates the tooth brushing instruction information sent by the processing device in the two following exemplary embodiments.

In a first exemplary embodiment, the tooth brushing instruction information sent by the processing device may be literal information, which may be displayed on the display screen of the terminal.

Exemplarily, as shown in FIG. 6, in the case that the current average tooth brushing score is 85 points, a text message, for example, “The tooth brushing quality is high. Please maintain the tooth brushing habit” may be displayed on the display screen.

In a second exemplary embodiment, the electric toothbrush includes an audio play component, and the tooth brushing instruction information may be audio information.

In this way, the processing device may send the tooth brushing instruction information to the electric toothbrush, such that the electric toothbrush plays the tooth brushing instruction information upon completion of tooth brushing.

Optionally, the tooth brushing instruction information includes at least one of first adjustment indication information of the effective tooth brushing duration and second adjustment indication information of the tooth brushing pressure. For example, in response to determining that the effective tooth brushing duration is too short based on the tooth brushing information, the processing device may send the first adjustment indication information to instruct the effective tooth brushing duration of the user of the electric toothbrush during tooth brushing. In response to determining based on the tooth brushing information that the tooth brushing pressure is too low or too high, the processing device may send the second adjustment indication information to instruct the tooth brushing pressure of the user of the electric toothbrush during tooth brushing.

Exemplarily, 306 may include, based on the tooth brushing information, inquiring a corresponding relationship between the tooth brushing information and the tooth brushing instruction information by the processing device, and sending the inquired tooth brushing instruction information. Exemplarily, the corresponding relationship between the tooth brushing information and the tooth brushing instruction information may be referred to the following Table 11.

TABLE 11

| Average tooth | | |
|---|---|---|
| brushing score in | | |
| tooth brushing | | Tooth brushing instruction |
| evaluation result | Tooth brushing data | information |
| 80 to 100 | / | The tooth brushing quality is high. |
| points | | Please maintain the tooth brushing |
| | | habit. |
| 1 to 79 | The effective tooth brushing duration is less | The tooth brushing quality is average. |
| points | than a second preset threshold | Please pay attention to increase the |
| | | effective tooth brushing duration. |
| | A sum of the duration proportion | The tooth brushing quality is average. |
| | corresponding to the large tooth brushing | Please pay attention to reduce the |
| | pressure and the duration proportion | tooth brushing pressure. |
| | corresponding to the higher tooth brushing | |
| | pressure is greater than 85% | |
| | The duration proportion corresponding to the | The tooth brushing quality is average. |
| | lower tooth brushing pressure is greater than | Please pay attention to increase the |
| | 85% | tooth brushing pressure. |
| 0 point | / | The tooth brushing quality is poor. |
| | | Please read the manual of the electric |
| | | toothbrush carefully and brush the |
| | | teeth correctly. |

Based on Table 11, it can be seen that in response to determining that the average tooth brushing score is between 1 and 79 points based on the tooth brushing information, and the effective tooth brushing duration is less than the second preset threshold, then the tooth brushing instruction information sent by the processing device may be “the tooth brushing quality is average; please pay attention to increase the effective tooth brushing duration.”

It should be noted that, the method for instructing tooth brushing according to the embodiment of the present disclosure may further include periodically outputting trend information of changes in the tooth brushing evaluation result for a preset duration.

Exemplarily, the preset duration may be one week or one month, etc. The trend information of changes in the tooth brushing evaluation result may include at least one of a change curve graph of the average tooth brushing score, a change curve graph of the tooth brushing duration score, and a change curve graph of the tooth brushing pressure score.

It should be further noted that most electric toothbrushes currently on the market may collect the tooth brushing duration and the tooth brushing pressure, and the processing device according to the embodiment of the present disclosure may acquire the tooth brushing duration and the tooth brushing pressure collected by the electric toothbrush, and acquire the tooth brushing evaluation result based on the tooth brushing duration and the tooth brushing pressure. Therefore, the method for instructing tooth brushing according to the embodiments of the present disclosure may be applicable to most electric toothbrushes on the market, and the method for instructing tooth brushing is more universal. For high-end electric toothbrushes, the tooth brushing data collected by the electric toothbrush may also include a duration that the toothbrush stays on each tooth brushing surface, a tooth brushing pressure on each tooth brushing surface, and a tooth brushing posture and other data. To this end, the processing device according to the embodiment of the present disclosure may also determine whether the tooth brushing time is appropriately distributed, whether the tooth brushing posture is correct, and whether the tooth brushing pressure on each tooth brushing surface is standard based on these tooth brushing data. In this way, the tooth brushing evaluation result and the tooth brushing instruction information may be refined, thereby further improving the tooth brushing quality.

It should also be noted that the sequence of the steps of the method for instructing tooth brushing according to the embodiments of the present disclosure may be adjusted appropriately, and the steps may also be added or subtracted accordingly. Various methods easily conceivable by anyone skilled in the art within the technical scope of the present disclosure should be included within the scope of protection of the present disclosure, and thus are not repeated here.

In summary, in the method for instructing tooth brushing according to the embodiment of the present disclosure, the tooth brushing evaluation result of a tooth brushing process is obtained by acquiring the tooth brushing data collected during the tooth brushing process of the electric toothbrush based on the target tooth brushing solution. In addition, based on at least one of the tooth brushing data and the tooth brushing evaluation result, the tooth brushing instruction information for instructing the user of the electric toothbrush to brush teeth may be sent. In this way, the user of the electric toothbrush learns about a tooth brushing quality of the current tooth brushing process by checking the tooth brushing evaluation result. In the case that the tooth brushing quality of the current tooth brushing process is poor, the user of the electric toothbrush may improve the next tooth brushing process by checking the tooth brushing instruction information to improve the subsequent tooth brushing quality, such that the user of the electric toothbrush can practice the target tooth brushing solution in a more standardized fashion in a subsequent tooth brushing process, and then can achieve a tooth brushing effect of the target tooth brushing solution.

FIG. 7 is a structural block diagram of an apparatus for instructing tooth brushing according to an embodiment of the present disclosure. The apparatus 400 for instructing tooth brushing may be integrated into the processing device 102 in the system 100 for instructing tooth brushing shown in FIG. 1. The apparatus 400 includes:

a data collecting module 401 configured to acquire, during a tooth brushing process of an electric toothbrush based on a target tooth brushing solution, tooth brushing data collected by the electric toothbrush, wherein the tooth brushing data includes: a tooth brushing duration and a tooth brushing pressure;

an evaluating module 402, configured to acquire a tooth brushing evaluation result based on the tooth brushing data;

an outputting module 403, configured to output the tooth brushing evaluation result; and

a sending module 404, configured to send tooth brushing instruction information based on tooth brushing information, wherein the tooth brushing information includes at least one of the tooth brushing evaluation result and the tooth brushing data, and the tooth brushing instruction information is configured to instruct a user of the electric toothbrush to brush teeth.

Optionally, the tooth brushing instruction information includes: at least one of first adjustment indication information of an effective tooth brushing duration and second adjustment indication information of the tooth brushing pressure, wherein the effective tooth brushing duration is a length of time where the tooth brushing pressure is greater than a pressure threshold.

Optionally, the tooth brushing evaluation result includes at least one of a tooth brushing duration score and a tooth brushing pressure score.

Optionally, in the case that the tooth brushing scoring result includes the tooth brushing duration score, the evaluating module 402 is configured to: acquire, based on the tooth brushing duration and the tooth brushing pressure, the effective tooth brushing duration, wherein the effective tooth brushing duration is a length of time where the tooth brushing pressure is greater than a pressure threshold; determine, in response to the effective tooth brushing duration being less than a first duration threshold, the tooth brushing duration score as a first preset score; determine, in response to the effective tooth brushing duration being greater than or equal to a second duration threshold, the tooth brushing duration score as a second preset score, wherein the second duration threshold is determined based on a total tooth brushing duration of the target tooth brushing solution; and determine, in response to the effective tooth brushing duration being less than the second duration threshold and greater than or equal to the first duration threshold, the tooth brushing duration score as a product of the second preset score and a target ratio, wherein the target ratio is a ratio of the effective tooth brushing duration to the second duration threshold.

Optionally, in the case that the tooth brushing evaluation result includes the tooth brushing pressure score, the evaluating module 402 is configured to: acquire, based on the tooth brushing pressure and the tooth brushing duration, a plurality of duration proportions one-to-one corresponding to a plurality of preset pressure ranges, wherein the duration proportion is a ratio of a duration of the tooth brushing pressure in a corresponding preset pressure range to the tooth brushing duration; determine, in response to a duration proportion corresponding to a first preset pressure range being greater than or equal to a proportion threshold, the tooth brushing pressure score as the first preset score; and determine, in response to the duration proportion corresponding to the first preset pressure range being less than the proportion threshold, the tooth brushing pressure score as a difference between the second preset score and an ineffective tooth brushing score, wherein the ineffective tooth brushing score is a sum of ineffective scores of preset pressure ranges other than a second preset pressure range, and the ineffective score of the preset pressure range is a product of a corresponding duration proportion and a corresponding weight coefficient.

Optionally, the tooth brushing evaluation result further includes an average tooth brushing score; and the evaluating module 402 is configured to calculate a weighted average of the tooth brushing duration score and the tooth brushing pressure score to acquire the average tooth brushing score.

Optionally, the sending module 404 is configured to inquire, based on the tooth brushing information, a corresponding relationship between the tooth brushing information and the tooth brushing instruction information, and send the inquired tooth brushing instruction information.

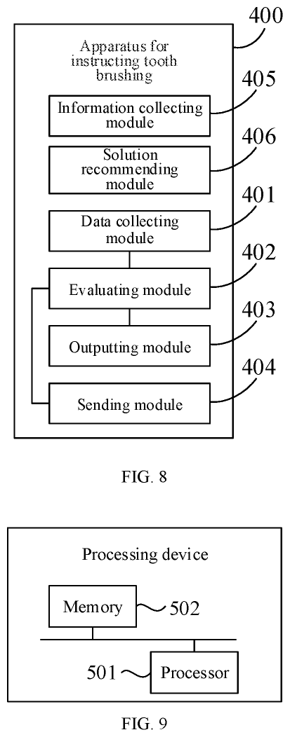

Optionally; as shown in FIG. 8, FIG. 8 is a structural block diagram of another apparatus for instructing tooth brushing according to an embodiment of the present disclosure. The apparatus 400 further includes:

an information collecting module 405, configured to acquire user information of the user of the electric toothbrush, wherein the user information includes at least one of age, gender, a tooth health condition, a gum health condition, a tooth color, a dietary habit, tooth filling or not, a user of a dental brace or not, pregnancy or not, a new user of the electric toothbrush or not, a tooth brushing habit and a care need; and

a solution recommending module 406, configured to recommend a tooth brushing solution to the user of the electric toothbrush based on the user information.

Optionally, the solution recommending module 406 is configured to recommend, by using a tooth brushing solution recommendation algorithm, the tooth brushing solution to the user of the electric toothbrush based on the user information.

The tooth brushing solution recommendation algorithm includes at least one of a rule-based recommendation algorithm, a collaborative filtering recommendation algorithm, and a demographic information-based recommendation algorithm.

In summary, in the apparatus for instructing tooth brushing according to the embodiment of the present disclosure, the tooth brushing evaluation result of a tooth brushing process is acquired by acquiring the tooth brushing data collected during the tooth brushing process of the electric toothbrush based on the target tooth brushing solution. In addition, based on at least one of the tooth brushing data and the tooth brushing evaluation result, the tooth brushing instruction information for instructing the user of the electric toothbrush to brush teeth may be sent. In this way, the user of the electric toothbrush learns about a tooth brushing quality of the current tooth brushing process by checking the tooth brushing evaluation result. In the case that the tooth brushing quality of the current tooth brushing process is lower, the user of the electric toothbrush may improve the next tooth brushing process by checking the tooth brushing instruction information to improve the subsequent tooth brushing quality, such that the user of the electric toothbrush can practice the target tooth brushing solution in a more standardized fashion in a subsequent tooth brushing process, and then can achieve a tooth brushing effect of the target tooth brushing solution.

An embodiment of the present disclosure further provides a processing device. As shown in FIG. 9, FIG. 9 is a schematic structural diagram of the processing device according to an embodiment of the present disclosure. The processing device may include a processor 501 and a memory 502 configured to store one or more instructions executable by the processor 501. The processor 501, when loading and executing the one or more instructions, is caused to perform the method for instructing tooth brushing according to the above method embodiments.

The processing device according to the present embodiment may perform the method for instructing tooth brushing according to the foregoing method embodiments, and principles of practice of the solution and technical effects thereof are similar, which are not repeated herein.

An embodiment of the present disclosure also provides a system for instructing tooth brushing. As shown in FIG. 1, the system for instructing tooth brushing 100 may include: an electric toothbrush 101 and a processing device 102. The processing device may be the processing device shown in FIG. 9. The processing device 102 may be a terminal or a server. It should be noted that FIG. 1 is illustrated schematically with an example where the processing device 102 serves as the terminal.

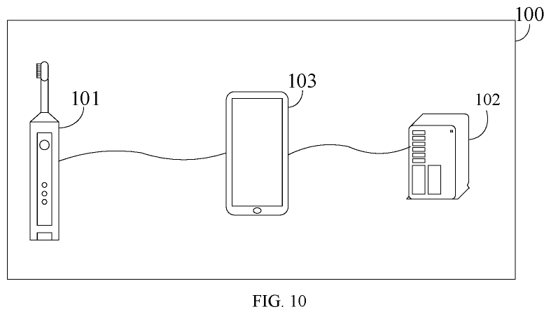

Optionally, as shown in FIG. 10, FIG. 10 is a schematic structural diagram of another system for instructing tooth brushing according to an embodiment of the present disclosure. In the case that the processing device 102 is a server 102, the system for instructing tooth brushing 100 may further include a terminal 103. The terminal 103 may be communicatively connected to the electric toothbrush 101, and the terminal 103 may also be communicatively connected to the server 102.

In this case, the terminal 103 is configured to receive tooth brushing data collected by the electric toothbrush 101, and send the tooth brushing data to the server. The terminal 103 is further configured to receive and display a tooth brushing evaluation result and tooth brushing instruction information sent by the server.

Those skilled in the art may clearly understand that, for the convenience and conciseness of the descriptions, specific working processes of the systems, apparatuses and modules described above may be referenced to corresponding processes in the above method embodiments, which are not repeated herein.

An embodiment of the present disclosure also provides a computer-readable storage medium storing one or more instructions therein. The computer-readable storage medium, when running on a processing component, causes the processing component to perform the method for instructing tooth brushing according to the above method embodiments.

Those skilled in the art should understand that the embodiments of the present disclosure may be provided as methods, systems, or computer program products. Therefore, the present disclosure may take a form of an entire hardware embodiment, an entire software embodiment, or an embodiment combining software and hardware. Furthermore, the present disclosure may take the form of the computer program products implemented on one or more computer-usable storage mediums containing computer-usable program codes.

The processor may be a central processing unit (CPU), and may also be other general processors, a digital signal processor (DSP), an application specific integrated circuit (ASIC), a field-programmable gate array (FPGA) or other programmable logic devices, discrete gate or transistor logic devices, or discrete hardware assemblies, etc. The general processor may be a microprocessor or any conventional processor, etc.

The memory may include the forms of a non-permanent memory, a random-access memory (RAM), and/or a non-volatile memory, such as a read-only memory (ROM) or a flash random-access memory (flash RAM). The memory is an example of the computer-readable medium.

The computer-readable medium includes permanent and non-permanent, removable and non-removable storage mediums. Storage media may be implemented by any method or technology for storing information, which may be computer-readable instructions, data structures, program modules or other data, Examples of the computer storage medium include, but not limited to, a phase-change RAM (PRAM), a static random-access memory (SRAM), a dynamic random-access memory (DRAM), other types of RAMS, a ROM, an electrically erasable programmable read-only memory (EEPROM), a flash memory or other memory technologies, a compact disc read-only memory (CD-ROM), a digital versatile disk (DVD) or other optical storage devices, a magnetic cassette-type magnetic tape, a magnetic disk storage or other magnetic storage devices, or any other non-transmission mediums that can be configured to store information for access by a computing device. As defined herein, the computer-readable medium does not include transitory media, such as modulated data signals and carrier waves.

Finally, it should be noted that the above embodiments are only configured to illustrate the technical solutions of the present disclosure instead of limiting the present disclosure. Although the present disclosure has been described in detail with reference to the above respective embodiments, those of ordinary skill in the art should understand that the technical solutions described in the foregoing embodiments may still be modified, or some or all of the technical features therein may be equivalently replaced. These modifications or replacements do not cause an essence of the corresponding technical solutions to deviate from scopes of the technical solutions of the embodiments of the present disclosure.

In addition, in the present disclosure, the terms “first” and “second” are only used for the purpose of description, and cannot be understood as indicating or implying a relative importance. The term “a plurality of” refers to two or more in number, unless otherwise defined.

1. A method for instructing tooth brushing, comprising:
acquiring, during a tooth brushing process of an electric toothbrush based on a target tooth brushing solution, tooth brushing data collected by the electric toothbrush, wherein the tooth brushing data comprises a tooth brushing duration and a tooth brushing pressure;
acquiring a tooth brushing evaluation result based on the tooth brushing data;
outputting the tooth brushing evaluation result; and
sending tooth brushing instruction information based on tooth brushing information, wherein the tooth brushing information comprises at least one of the tooth brushing evaluation result and the tooth brushing data, and the tooth brushing instruction information is configured to instruct a user of the electric toothbrush to brush teeth.

2. The method according to claim 1, wherein the tooth brushing instruction information comprises at least one of first adjustment indication information of an effective tooth brushing duration and second adjustment indication information of the tooth brushing pressure, wherein the effective tooth brushing duration is a length of time where the tooth brushing pressure is greater than a pressure threshold.

3. The method according to claim 1, wherein the tooth brushing evaluation result comprises at least one of a tooth brushing duration score and a tooth brushing pressure score.

4. The method according to claim 3, wherein in response to the tooth brushing evaluation result comprising the tooth brushing duration score, acquiring the tooth brushing evaluation result based on the tooth brushing data comprises:
acquiring, based on the tooth brushing duration and the tooth brushing pressure, an effective tooth brushing duration, wherein the effective tooth brushing duration is a length of time where the tooth brushing pressure is greater than a pressure threshold;
determining, in response to the effective tooth brushing duration being less than a first duration threshold, the tooth brushing duration score as a first preset score;
determining, in response to the effective tooth brushing duration being greater than or equal to a second duration threshold, the tooth brushing duration score as a second preset score, wherein the second duration threshold is determined based on a total tooth brushing duration of the target tooth brushing solution; and
determining, in response to the effective tooth brushing duration being less than the second duration threshold and greater than or equal to the first duration threshold, the tooth brushing duration score as a product of the second preset score and a target ratio, wherein the target ratio is a ratio of the effective tooth brushing duration to the second duration threshold.

5. The method according to claim 3, wherein in response to the tooth brushing scoring result comprising the tooth brushing pressure score, acquiring the tooth brushing evaluation result based on the tooth brushing data comprise:
acquiring, based on the tooth brushing pressure and the tooth brushing duration, a plurality of duration proportions one-to-one corresponding to a plurality of preset pressure ranges, wherein the duration proportion is a ratio of a duration of the tooth brushing pressure in a corresponding preset pressure range to the tooth brushing duration;
determining, in response to a duration proportion corresponding to a first preset pressure range being greater than or equal to a proportion threshold, the tooth brushing pressure score as a first preset score; and
determining, in response to the duration proportion corresponding to the first preset pressure range being less than the proportion threshold, the tooth brushing pressure score as a difference between the second preset score and an ineffective tooth brushing score, wherein the ineffective tooth brushing score is a sum of ineffective scores of preset pressure ranges other than a second preset pressure range, the ineffective score of the preset pressure range being a product of a corresponding duration proportion and a corresponding weight coefficient.

6. The method according to claim 3, wherein the tooth brushing evaluation result further comprises an average tooth brushing score; and acquiring the tooth brushing evaluation result based on the tooth brushing data comprises:
calculating a weighted average of the tooth brushing duration score and the tooth brushing pressure score to acquire the average tooth brushing score.

7. The method according to claim 1, wherein sending the tooth brushing instruction information based on the tooth brushing information comprises:
inquiring, based on the tooth brushing information, a corresponding relationship between the tooth brushing information and the tooth brushing instruction information, and sending inquired tooth brushing instruction information.

8. The method according to claim 1, wherein prior to acquiring the tooth brushing data collected by the electric toothbrush, the method further comprises:
acquiring user information of the user of the electric toothbrush, wherein the user information comprises at least one of age, gender, a tooth health condition, a gum health condition, a tooth color, a dietary habit, tooth filling or not, a user of a dental brace or not, pregnancy or not, a new user of the electric toothbrush or not, a tooth brushing habit and a care need; and
recommending a tooth brushing solution to the user of the electric toothbrush based on the user information.

9. The method according to claim 8, wherein recommending the tooth brushing solution to the user of the electric toothbrush based on the user information comprises:
recommending, by using a tooth brushing solution recommendation algorithm, the tooth brushing solution to the user of the electric toothbrush based on the user information;
wherein the tooth brushing solution recommendation algorithm comprises at least one of a rule-based recommendation algorithm, a collaborative filtering recommendation algorithm, and a demographic information-based recommendation algorithm.

10-18. (canceled)

19. A processing device, comprising: a processor, and a memory configured to store one or more instructions executable the processor; wherein the processor, when loading and executing the one or more instructions, is caused to perform a method for instructing tooth brushing comprising:
acquiring, during a tooth brushing process of an electric toothbrush based on a target tooth brushing solution, tooth brushing data collected by the electric toothbrush, wherein the tooth brushing data comprises a tooth brushing duration and a tooth brushing pressure;
acquiring a tooth brushing evaluation result based on the tooth brushing data;
outputting the tooth brushing evaluation result; and
sending tooth brushing instruction information based on tooth brushing information, wherein the tooth brushing information comprises at least one of the tooth brushing evaluation result and the tooth brushing data, and the tooth brushing instruction information is configured to instruct a user of the electric toothbrush to brush teeth.

20. A system for instructing tooth brushing, comprising: an electric toothbrush, and a processing device communicatively connected to the electric toothbrush, wherein the processing device is the processing device as defined in claim 19.

21. The system for instructing tooth brushing according to claim 20, wherein the processing device is a server, and the system for instructing tooth brushing further comprises a terminal,
wherein the terminal is communicatively connected to the electric toothbrush and the server;
the terminal is configured to receive tooth brushing data collected by the electric toothbrush, and send the tooth brushing data to the server; and
the terminal is further configured to receive and display a tooth brushing evaluation result and tooth brushing instruction information sent by the server.

22. A computer-readable storage medium storing one or more instructions therein, wherein the readable storage medium, when running on a processing component, causes the processing component to perform a method for instructing tooth brushing comprising:
acquiring, during a tooth brushing process of an electric toothbrush based on a target tooth brushing solution, tooth brushing data collected by the electric toothbrush, wherein the tooth brushing data comprises a tooth brushing duration and a tooth brushing pressure;
acquiring a tooth brushing evaluation result based on the tooth brushing data;
outputting the tooth brushing evaluation result; and
sending tooth brushing instruction information based on tooth brushing information, wherein the tooth brushing information comprises at least one of the tooth brushing evaluation result and the tooth brushing data, and the tooth brushing instruction information is configured to instruct a user of the electric toothbrush to brush teeth.

23. The processing device according to claim 19, wherein the tooth brushing instruction information comprises at least one of first adjustment indication information of an effective tooth brushing duration and second adjustment indication information of the tooth brushing pressure, wherein the effective tooth brushing duration is a length of time where the tooth brushing pressure is greater than a pressure threshold.

24. The processing device according to claim 19, wherein the tooth brushing evaluation result comprises at least one of a tooth brushing duration score and a tooth brushing pressure score.

25. The processing device according to claim 24, wherein in response to the tooth brushing evaluation result comprising the tooth brushing duration score, acquiring the tooth brushing evaluation result based on the tooth brushing data comprises:
acquiring, based on the tooth brushing duration and the tooth brushing pressure, an effective tooth brushing duration, wherein the effective tooth brushing duration is a length of time where the tooth brushing pressure is greater than a pressure threshold;
determining, in response to the effective tooth brushing duration being less than a first duration threshold, the tooth brushing duration score as a first preset score;
determining, in response to the effective tooth brushing duration being greater than or equal to a second duration threshold, the tooth brushing duration score as a second preset score, wherein the second duration threshold is determined based on a total tooth brushing duration of the target tooth brushing solution; and
determining, in response to the effective tooth brushing duration being less than the second duration threshold and greater than or equal to the first duration threshold, the tooth brushing duration score as a product of the second preset score and a target ratio, wherein the target ratio is a ratio of the effective tooth brushing duration to the second duration threshold.

26. The processing device according to claim 24, wherein in response to the tooth brushing scoring result comprising the tooth brushing pressure score, acquiring the tooth brushing evaluation result based on the tooth brushing data comprise:
acquiring, based on the tooth brushing pressure and the tooth brushing duration, a plurality of duration proportions one-to-one corresponding to a plurality of preset pressure ranges, wherein the duration proportion is a ratio of a duration of the tooth brushing pressure in a corresponding preset pressure range to the tooth brushing duration;
determining, in response to a duration proportion corresponding to a first preset pressure range being greater than or equal to a proportion threshold, the tooth brushing pressure score as a first preset score; and
determining, in response to the duration proportion corresponding to the first preset pressure range being less than the proportion threshold, the tooth brushing pressure score as a difference between the second preset score and an ineffective tooth brushing score, wherein the ineffective tooth brushing score is a sum of ineffective scores of preset pressure ranges other than a second preset pressure range, the ineffective score of the preset pressure range being a product of a corresponding duration proportion and a corresponding weight coefficient.

27. The processing device according to claim 24, wherein the tooth brushing evaluation result further comprises an average tooth brushing score; and acquiring the tooth brushing evaluation result based on the tooth brushing data comprises:
calculating a weighted average of the tooth brushing duration score and the tooth brushing pressure score to acquire the average tooth brushing score.

28. The processing device according to claim 19, wherein sending the tooth brushing instruction information based on the tooth brushing information comprises:
inquiring, based on the tooth brushing information, a corresponding relationship between the tooth brushing information and the tooth brushing instruction information, and sending inquired tooth brushing instruction information.

29. The processing device according to claim 19, wherein prior to acquiring the tooth brushing data collected by the electric toothbrush, the method further comprises:
acquiring user information of the user of the electric toothbrush, wherein the user information comprises at least one of age, gender, a tooth health condition, a gum health condition, a tooth color, a dietary habit, tooth filling or not, a user of a dental brace or not, pregnancy or not, a new user of the electric toothbrush or not, a tooth brushing habit and a care need; and
recommending a tooth brushing solution to the user of the electric toothbrush based on the user information.
